(19) United States
(12) Patent Application Publication
(10) Pub. No.: US 2005/0075889 A1
(43) Pub. Date: Apr. 7, 2005

(54) Progressive customer reward program

(76) Inventors: Dennis C. Gomes, Absecon, NJ (US); Gary Van Hettinga, Egg Harbor Township, NJ (US); Mary Tindall, Egg Harbor Township, NJ (US); Nick Kontonicolas, Egg Harbor Township, NJ (US)

Correspondence Address: SUGHRUE MION, PLLC, 2100 Pennsylvania Avenue, NW, Washington, DC, 20037-3213, US

(21) Appl. No.: 10/674,468

(22) Filed: Oct. 1, 2003

(51) Int. Cl. G06F 17/60

(52) U.S. Cl. 705/1; 705/14

(57) ABSTRACT

A method and system for rewarding customers of a casino. The method and system include establishing a game to participate in the method and system. Further included is placing a wager on the game by a player and obtaining points. The player accumulates a qualifying amount of points, so as to be eligible to reach a first reward level. After the player has reached the first reward level, the player has a choice to choose a first gift. Additional points are accumulate and added to the qualifying amount of points to form a cumulative amount of points. A second reward level is then reached and the player can choose an additional gift. The player then strives to reach multiple more rewards levels with varying gifts, while the amount of points obtained continue to accumulate without being reset to zero.

### BACKGROUND OF THE INVENTION

1. Field of the Invention

Methods consistent with the present invention relate to a customer reward program. Illustrative embodiments of the invention relate to methods and systems that provide incentive for players of casino games to return to the casino.

2. Description of Related Art

The gaming industry, and in particular casinos, constantly seek new ways to attract and retain players of games, such as slot machines. The competition amongst casinos has intensified in recent years due to the opening of new casinos and new jurisdictions that have legalized gambling. Due to players having many casinos to choose from, it has become important for casinos to satisfy and retain customers. Casinos are constantly attempting to develop marketing strategies that are aimed at retaining players.

It is known to attract and retain players by offering complimentary rewards. These rewards are commonly known in the industry as “comps.” Comps are typically awarded based on a player's average wager and time played. They often include free meals, drinks, hotel accommodations and the like. The purpose of the comp programs is to build and maintain customer loyalty while providing a material return even when a player is not successful at a casino game.

An example of a comp program includes granting a player a particular amount of points for spending a predetermined amount of money at the casino. Once a certain amount of points are obtained, the player may have the option of choosing a particular reward. After the reward is claimed, the customer's points are reset to zero. New points must be earned to obtain an additional gift. However, once a player has already accumulated points to obtain a particular gift, there is little incentive for the player to re-accumulate points just to obtain a gift similar to what was previously won. Moreover, current comp programs do not provide players with the incentive to remain loyal to one program or place since they reward players for what they did “today” or on this trip only. Thus, a need exists for a method and system for providing a player with rewards that are attractive enough to bring the player back to the casino, time after time.

### SUMMARY OF THE INVENTION

Illustrative, non-limiting embodiments of the present invention overcome the disadvantages described above and other disadvantages. Also, the present invention is not required to overcome the disadvantages described above and the other disadvantages, and an illustrative, non-limiting embodiment of the present invention may not overcome any of the disadvantages.

An illustrative, non-limiting embodiment of the present invention provides a method of rewarding players of a game at a casino. The method includes establishing a first game and placing a wager on the first game by a player. A first number of points is awarded to the player and the points are recorded. Additional points are accumulated until the player reaches a first reward level. After the player has reached the first reward level, the player has a choice to choose a first gift. The player then continues to accumulate additional points by playing the first game or at least one second game, and the additional points are recorded so that they are added to previously acquired points to form a cumulative amount of points. Further points are then added to the cumulative amount of points, so as to exceed a second predetermined amount of points, which places the player at a second reward level. After reaching the second reward level, the player is presented with a choice to choose a second gift.

In another illustrative, non-limiting embodiment of the present invention, the first game and the at least one second game are slot machines. Also, the player uses a data card, either proceeding or following the placing of a wager, so as to communicate the player's information to the game. In this further embodiment, before the player is able to reach the first reward level, the player must first obtain a qualifying status. The qualifying status is obtained by accumulating a predetermined amount of points in one trip to the casino. After the player has accumulated the predetermined amount of points to reach the qualifying status, he may then continue to obtain additional points in an effort to reach the first reward level. The methods and systems of the present invention may provide multiple reward levels in addition to the first and second reward levels. Certain levels may have limited edition gifts that are provided on a first-come, first-serve basis.

Another illustrative, non-limiting embodiment of the present invention provides for practicing the method for only a limited amount of days at the casino. Also, there may be designated times where double points are awarded to the player. These designated times, for example, may include particular weekdays, after midnight, and birthdays.

An even further illustrative, non-limiting embodiment of the present of invention provides a system for rewarding play of a casino game during a promotional period. The system includes a plurality of casino games having an input device for receiving information pertaining to a player. A compensation machine is also provided that stores and/or displays an amount of points that the player has accumulated. The compensation machine allows for the player to view a total amount of points that have been accumulated and an amount of points that are needed to reach at least one of a plurality of reward levels. The compensation machine is also capable of depicting a photo of gifts available at the various reward levels. Further, a redeem button is provided on the compensation machine, which the player actuates after reaching one of the plurality of reward levels, so as retain a receipt, which can be presented for a gift.

The total amount of points displayed at the compensation machine is representative of all the points acquired during the promotional period for a particular player. If the player has surpassed a reward level, the total amount of points is equal to the amount of points needed to surpass the reward level, plus the amount of points obtained in addition to the points needed to surpass the level. In other words, the points are cumulatively obtained throughout the plurality of reward levels.

The cumulative acquisition of points is one of the main features of the present invention. It presents a goal for the players which is not diminished after obtaining a first level gift, but instead, continues to provide further, and more gratifying goals. Moreover, the present invention provides players with the incentive to play to the next level to obtain a more valuable reward; in addition to providing better rewards for long-term players and frequent players. Also, the rewards and choices at each level provide more variety to appeal to everyone.

### BRIEF DESCRIPTION OF THE DRAWINGS

Aspects of illustrative, non-limiting embodiments of the present invention will become more apparent by describing in detail non-limiting embodiments thereof with reference to the attached drawings, in which:

FIG. 1 is a schematic diagram of a system according to one embodiment of the present invention;

FIG. 2 is a flow chart illustrating steps of a non-limiting embodiment of the present invention;

FIG. 3 is a flow chart illustrating steps of a further non-limiting aspect of the present invention; and

FIG. 4 is a flow chart illustrating steps of an additional non-limiting aspect of the present invention.

### DETAILED DESCRIPTION OF THE ILLUSTRATIVE, NON-LIMITING EMBODIMENTS

The following description of illustrative, non-limiting embodiments of the invention discloses specific configurations, components, processes and operations. However, the embodiments are merely examples of the present invention and, thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, processes and operations of the embodiments that are known to one skilled in the art are omitted for the sake of clarity and brevity.

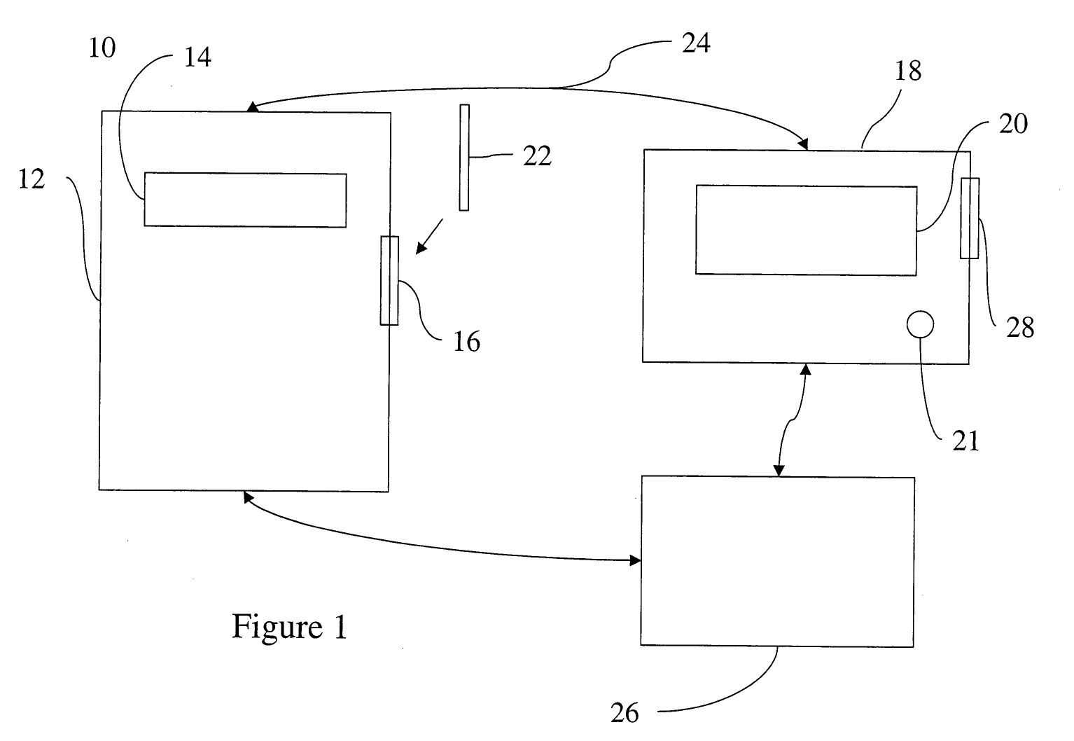

Certain preferred embodiments of the present invention will now be described with reference to the drawings. Turning first to FIG. 1, there is shown a system 10 according to one embodiment of the present invention. In general, the system includes a casino game 12, for example, a slot machine, (hereinafter “game”) having a display panel 14 for depicting features of the game, and a card reader 16. The card reader 16 may be an integral part of the game 12, or a separate unit that is in communication with the game 12.

A compensation machine 18 is adapted to be in communication with the game 12. The compensation machine includes a screen, or means for viewing, 20 which depicts, as described in further detail below, various gifts that are available at respective reward levels. The compensation machine 18 also includes a redeem button 21. Communication between the compensation machine 18 and game 12 is made through a hard wire communication network 24, or alternatively, as one skilled in the art would appreciate, may be made through a wireless communication system.

The card reader 16 of the game 12 is operative to read a player's information or data card (hereinafter “card”) 22 and store or transmit information pertaining to the player. For example, guests may apply for a free card by visiting a promotion booth and filling out an application. The application may require information, such at age, a valid ID, address, telephone number, e-mail address and date of birth. The information read from the card 22 may be transferred to a data base 26, or a memory in the compensation machine 18. As will be discussed further below, the transferred information includes data pertaining to reward points accumulated by the player.

The data base 26 communicates with the compensation machine 18, and is also capable of communicating with multiple other games. These additional games are also equipped with a card reader 16 for inputting a player's information. Thus, a network is provided that is capable of sharing and storing information pertaining to a particular player.

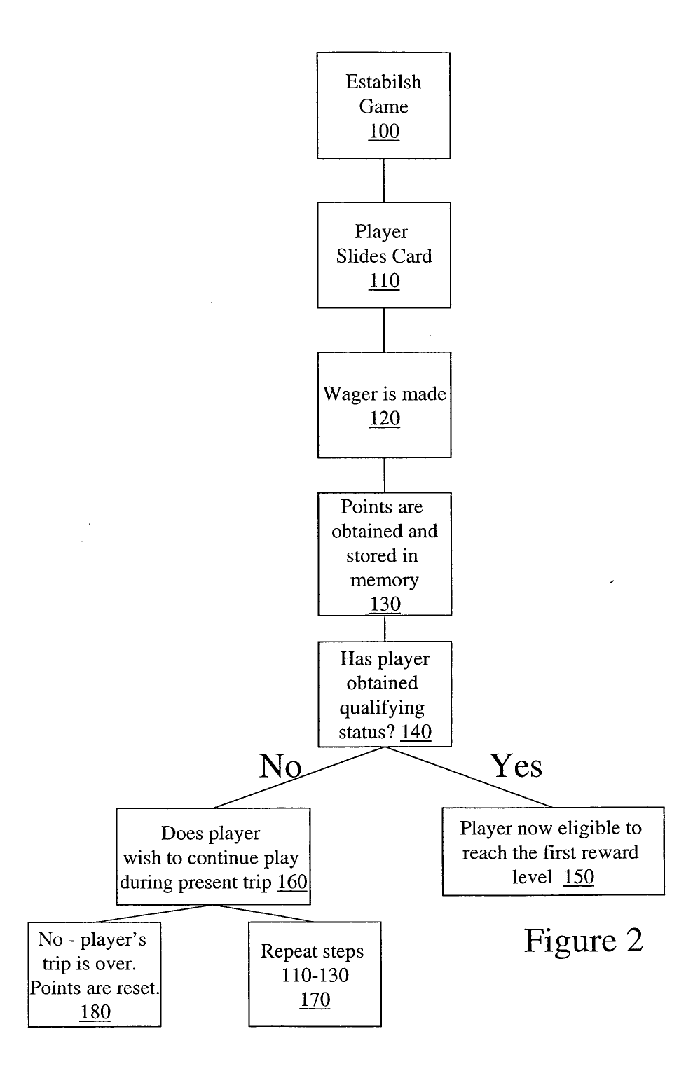

Having described the components of the system, operation of the system and reward program will now be described. It is to be understood that the operation of the system, as described below, is controlled primarily by programs stored within the respective components and executed in the circuitry of the system. With additional reference to FIG. 2, a particular game to be implemented into the system is established (step 100) with the card reader 16 and means of communicating with the compensation machine 18 and/or data base 26. It will be appreciated that the compensation machine 18 and data base 26 can be integrally provided in one unit. Then, a player who has obtained an information card, slides the card 22 through the card reader 16 of the game 12 (step 110). The player then determines the amount of money that is to be wagered for the round of play (step 120). Once the play is complete, an amount of points is assigned to the player (step 130). The points are stored in a ROM of the game 12, or directly communicated to the compensation machine 18 and/or the data base 26.

To qualify as an official participant in the reward program, and receive gifts, a player must obtain a qualifying status. A qualifying status is obtained by accumulating a predetermined amount of points. In one embodiment, the points required for the qualifying status need to be acquired in a set time period, for example, during one trip to the casino. One trip may be defined as a 24-hour period. An exemplary embodiment defines trip as a period (not to exceed seven days) when there is no activity registered on the player's account for a 24-hour period. However, other definitions may be provided.

Once it is determined that the player has obtained a qualifying status (step 140), the player remains in the program regardless of the amount of points that are further accumulated. Obtaining qualifying status also makes the player eligible to reach a first reward level (step 150). If the player has not obtained a qualifying status, the player decides whether to continue play or stop play (step 160). If it is decided to continue play, steps 110-130 are repeated in an effort to accumulate enough points to obtain the qualifying status (step 170). If the player has not obtained qualifying status, and if the player does not desire to continue play during the present trip, as according to one embodiment of the present invention, the points will be reset to zero (0) (step 180).

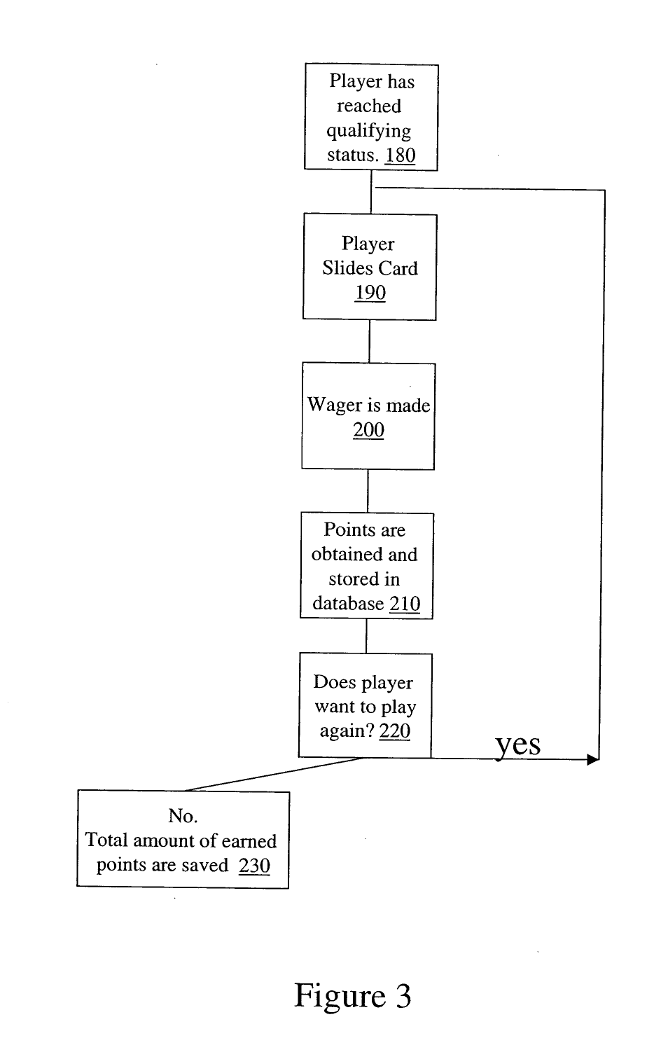

With additional reference to FIG. 3, after the player has obtained the qualifying status (step 180), the player is eligible to reach the first reward level by resuming play. In particular, steps 190-220 are carried out so as to accumulate additional points. These steps are similar to steps 110-130 described above in the sense that the player slides his identification card 22 through the card reader 16 (step 190); places a wager (step 200), and obtains additional points (step 210). The obtained points are continually stored in either the memory of the game 12, the compensation machine 18 and/or the date base 26 so that they are cumulatively increased. If after a player has obtained a qualifying status, the player decides that no further games will be played, the total amount of earned points are maintained and recorded (step 230).

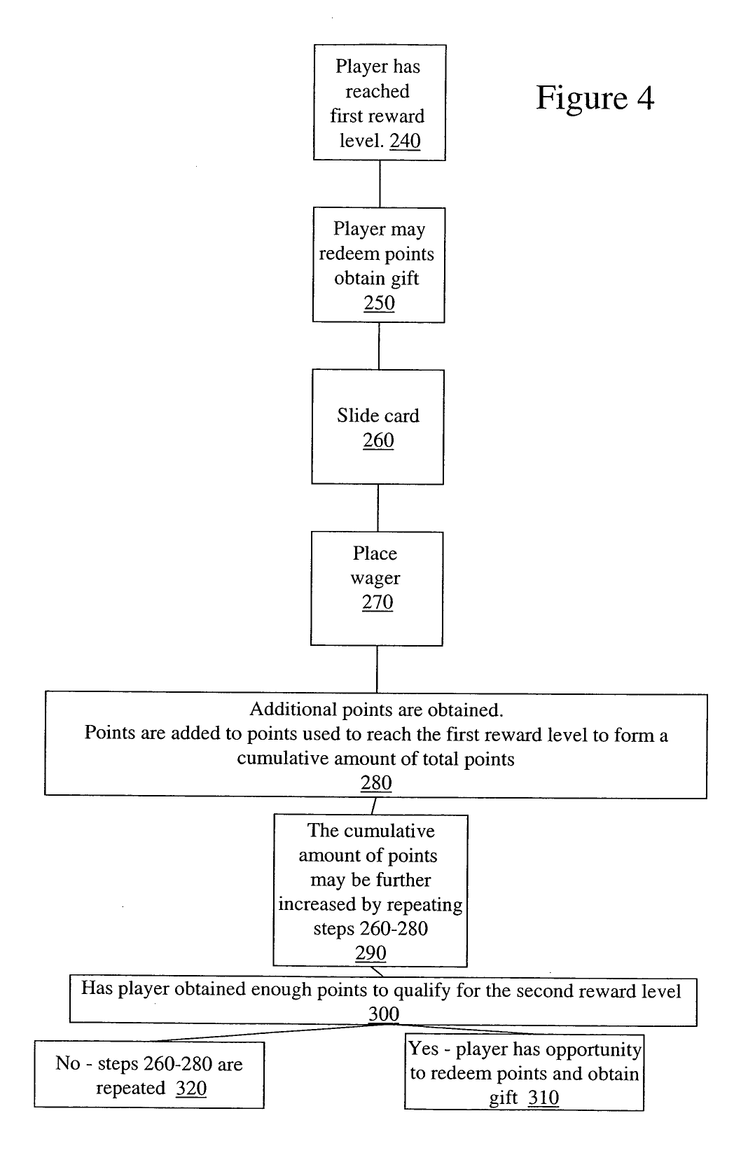

With additional reference to FIG. 4, the player continues to accumulate points by playing one of the established games 12 until enough points are earned to reach the first reward level (step 240). Once the first reward has been reached, the player will have an option to redeem the accumulated points and obtain a gift (step 250). To redeem points, the players visits the compensation machine 18 and enters identification information. This may be done by manually entering a password and user ID, or preferably, by sliding the information card 22 through a reader 28 on the compensation machine 18. The display screen 20 provides information to the players such as the total amount of accumulated points for the promotional period; points needed to reach the qualifying or next reward level; and gifts available at the various levels. According to one embodiment of the present invention, a catalog will be produced which contains the various gifts provided at the respective levels. This will permit the player to know in advance the gifts provided at each reward level, and the amount of points required to reach the reward levels.

One enough points are accumulated to reach a reward level, the redeem button 21 is depressed, and a gift receipt is provided. The redeem button 21 may be separate from the display screen 20 as shown in FIG. 1 or, alternately, incorporated into the display screen 22. An illustrative example of a gift receipt may indicate the name of the player, account number, date, time and instructions as to where and how to obtain the gift. Upon taking the gift receipt to an operations manager of the casino, the player will sign the receipt and will either be issued the gift, or have the gift sent to a mailing address. The system will then be updated to represent that the particular gift for the respective level has been obtained.

Alternatively, the player may decide to not redeem his points for a gift at this time, but instead, continue to accumulate points. It is important to note that if the player decides to redeem his points, the accumulated amount of points is not reset to zero. For example, if 100 points are obtained to reach the first reward level, and the player wishes to redeem the points to obtain a gift, he still maintains 100 points. Any additional obtained points are then added to the 100 points and are used to reach a higher reward level. In particular, points are further accumulated by performing additional steps, which include the sliding of the player's personal card into the card reader 16 (step 260), placing of a wager (step 270), and obtaining further points which are automatically stored in one of the aforementioned databases or memories. These steps are subsequently repeated (step 290).

The player then attempts to obtain a further predetermined amount of points so as to reach a threshold requirement of a second reward level (step 300). If the player has earned a sufficient amount of points to reach the second reward level, the points may be redeemed and a second gift may be obtained (step 310). If the player has not obtained enough points to reach the second reward level, the player may resume playing the game 12 or any other participating game, so as to obtain additional points, as described above (step 320).

The goal of every casino is to make the gambling experience enjoyable, such that players return to gamble more. One feature of the present invention that provides such an enjoyable experience is the continuing accumulation of points. For example, once a player has reached the first reward level in step 240, he is eligible to receive a gift, which may be selected from a plurality of different gifts. Then, the player may continue to accumulate additional points in an effort to reach a second reward level. However, the player's points are not reset back to zero after the first reward level has been reached. Instead, the points are accumulatively increased, so that the player is driven to reach a second reward level.

More specifically, the first level may have a 100-point threshold wherein, once the player obtains 100 points, he is eligible for a gift. The second level, for example, may have a threshold level of 250 points. After the player reaches the first reward level (requiring 100 points), the points are not reset to zero (0), but are added to further obtained points. Thus, after the player reaches the first reward level requiring 100 points, the player must then obtain an additional 150 points to give the player a total of 250 points, which will place him at the second reward level. Reaching the second reward level presents the player with an opportunity to choose different and more valuable gifts, in comparison to those obtained at the first reward level.

Up to this point, the reaching of the first reward level and second reward level have been described. However, any number of reward levels may be implemented in the methods and systems of the present invention to accommodate the needs and intentions of the casino. As an illustrative non-limiting example, a reward program may have 18 levels, and runs for a period of 18 months. The process of escalating to higher reward levels is done in the same manner described above in regard to going from first reward level to the second reward lever. Below is an illustrative table containing 18 levels. The table also depicts, by way of example, points required to get to each level, a number of players that may qualify, gift options and gift value.

TABLE 1

| | Required | | | | | | |
|---|---|---|---|---|---|---|---|
| | Points to | | | | | | |
| | Reach | Theoretical | | Players | Gift | | |
| Level | Level | Points | | Qualified | Options | Gift Value | |
| 1 | 100 | $ | 1,000.00 | 43,732 | 8-10 | $ | 10 |
| 2 | 250 | $ | 2,500.00 | 21,502 | 8-10 | $ | 15 |
| 3 | 500 | $ | 5,000.00 | 11,158 | 8-10 | $ | 25 |
| 4 | 750 | $ | 7,500.00 | 7,251 | 8-10 | $ | 25 |
| 5 | 1,000 | $ | 10,000.00 | 4,252 | 8-10 | $ | 25 |
| 6 | 1,500 | $ | 15,000.00 | 3,289 | 8-10 | $ | 50 |
| 7 | 2,000 | $ | 20,000.00 | 2,239 | 8-10 | $ | 50 |
| 8 | 3,000 | $ | 30,000.00 | 1,246 | 8-10 | $ | 100 |
| 9 | 4,000 | $ | 40,000.00 | 771 | 8-10 | $ | 100 |
| 10 | 5,000 | $ | 50,000.00 | 530 | 8-10 | $ | 300 |
| 11 | 7,500 | $ | 75,000.00 | 239 | 8-10 | $ | 500 |
| 12 | 10,000 | $ | 100,000.00 | 131 | 8-10 | $ | 1,000 |
| 13 | 12,500 | $ | 125.000.00 | 80 | 8-10 | $ | 1,000 |
| 14 | 15,000 | $ | 150,000.00 | 42 | 8-10 | $ | 1,000 |
| 15 | 25,000 | $ | 250,000.00 | 11 | 8-10 | $ | 2,000 |
| 16 | 35,000 | $ | 350,000.00 | 3 | 8-10 | $ | 2,000 |
| 17 | 55,000 | $ | 550,000.00 | 0 | 8-10 | $ | 4,000 |
| 18 | 60,000 | $ | 600,000.00 | 0 | 8-10 | $ | 10,000 |

As the level increases, the value of the gift increases or at least remains constant. Inversely, the number of players that qualify for each level decreases as the levels increase. A theoretical amount of points is associated with the required points to reach the respective levels. The theoretical points are the estimated gaming value to obtain the number of required points to reach that particular level. The theoretical gaming value is arrived at by, for example, the following equation: handle (coin in)×hold %=theoretical value. Each point earned equals $10 in theoretical.

On higher levels, for example, beginning on level 9, there may be limited edition prizes available, which are presented for redemption on a first come first serve basis. An illustrative amount of limited edition gifts that can be available at these higher levels is between 1 and 10. These gifts may include, but are not limited to, Swarovski Crystal, Tiffany Jewelry, Leroy Nieman Seriograph, Sports Memorabilia, and Llardo Figurines. The present invention also presents a player with the ability to jump levels. There may be a monthly process that calculates the player's most recent five-trip theoretical gaming average. The players are then leveled 1-20 where level 1 is the most valuable.

By awarding not only winning players, but also losing players, with points, a casino can attract and retain loyal patrons. The players will continue to play because even if they lose money, they can still obtain points and gifts. It will also be understood that speed of play is of paramount importance to a casino, because the speed of play is directly proportional to the amount wagered by players and won by the casino. Based on the foregoing description, it will be apparent to those skilled in the art that operation of the present invention is performed without slowing normal play. Human intervention is minimal, because of the automated system used for reading the player's information, accumulating points, and providing gift receipts.

Although the invention is shown and described in some instances as incorporating a slot machine, it will be appreciated that additional types of games may be configured to work with the system or program. These games may include table games or the like.

Although the invention is described as requiring a qualifying status to be obtained during one trip, it will be appreciated that the qualifying status could be required to be obtained during any predetermined time, such as two trips or a set number of days, or the like.

Although the invention describes a sequence of using a data card to communicate information of the player; placing a wager on a game by a player; and awarding a first number of points to the player, if will be appreciated that this order may be altered. For example, it is contemplated that points are awarded for each play of a game irrespective of the amount wagered. Thus, the points may be awarded before placing a wager.

The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein, but is to be accorded the widest scope as defined by the limitations of the claims and equivalents thereof.

1. A method of rewarding players of a table game at a casino, the method comprising:
establishing a first casino game to be part of a reward program;
placing a wager on the first game by a player;
awarding a first number of points to the player;
recording the first number of points;
accumulating additional points that are added to the first number of points so as to place the player at a first reward level;
presenting the player with a choice to choose a first gift after reaching the first reward level;
accumulating additional points by playing the first game or at least one second game, the additional points being recorded so that they are added to the points used to reach the first reward level so as to form a cumulative amount of points;
further adding to the cumulative amount of points so as to exceed a second predetermined amount of points which puts the player at a second reward level; and
after reaching the second reward level, presenting the player with a choice to choose a second gift.

2. The method according to claim 1, wherein the first game and the at least one second game are slot machines.

3. The method according to claim 1, further including the use of a data card either preceding or following said placing of a wager so as to communicate information of the player.

4. The method of claim 1, wherein the second gift is of a greater monetary value than the first gift.

5. The method according to claim 1, wherein said player must first obtain a qualifying status before being eligible to reach the first reward level, the qualifying status being obtained by acquiring a predetermined amount of points.

6. The method according to claim 5, wherein the qualifying status must take place in one 24-hour trip to the casino.

7. The method according to claim 1, wherein after reaching a predetermined reward level, which is higher than said second reward level, the player can choose from limited edition gifts and standard gifts, wherein the number of standard gifts is greater than the number of limited edition gifts.

8. The method according to claim 1, wherein said method is practiced for only a limited amount of days at the casino.

9. The method according to claim 1, wherein the first number of points awarded and the additional points awarded are doubled for the player during a designated time period when either of the first or at least one second game is played.

10. The method according to claim 9, where the designated time is on a weekday.

11. The method according to claim 9, where the designated time is after midnight.

12. The method according to claim 9, where the designated time is on a birthday of the player.

13. The method according to claim 1, wherein the player can reach up to eighteen total reward levels.

14. A system for rewarding play of a casino game during a promotional period, comprising:
a plurality of casino games;
an input device for receiving information pertaining to a player;
a compensation machine;
means for outputting points of the player from the plurality of casino games to said compensation machine;
means for viewing at the compensation machine, a status of the player, said status including,
a total amount of points that the player has accumulated; and
an amount of points needed to reach at least one of a plurality of reward levels,
wherein said total amount of points is representative of all points acquired during the promotional period and if the player has surpassed one of said plurality of reward levels, the total amount of points is equal to the amount of points needed to surpass said one of said plurality of reward levels plus the amount of points obtained in addition to the amount of points needed to surpass said one of said plurality of reward levels.

15. The system for rewarding play of claim 14, wherein said compensation machine depicts a photo of gifts available at various ones of the plurality of reward levels.

16. The system for rewarding play of claim 14, wherein said compensation machine includes a redeem button that the player actuates after reaching one of said plurality of reward levels to obtain a gift receipt.

17. A method of rewarding players of a game, the method comprising:
placing a wager on a first game by a player;
awarding a first number of points to the player;
accumulating additional points that are added to the first number of points so as to place the player at a first reward level;
presenting the player with a choice to choose a first gift after reaching the first reward level;
accumulating additional points by playing the first game or at least one second game, the additional points being added to the points used to reach the first reward level so as to form a cumulative amount of points; and
further adding to the cumulative amount of points so as to exceed a second predetermined amount of points which puts the player at a second reward level.

18. A system for rewarding play of a game, comprising:
a compensation machine;
means for outputting points of a player, from a game to said compensation machine;
means for viewing at the compensation machine, a status of the player, said status including,
a total amount of points that the player has accumulated,
wherein said total amount of points is representative of all points acquired if the player has surpassed one of a plurality of reward levels, the total amount of points including an amount of points needed to surpass said one of said plurality of reward levels in addition to an amount of points obtained after reaching said one of said plurality of reward levels.
